(19) United States
(12) Patent Application Publication
(10) Pub. No.: US 2026/0257812 A1
(43) Pub. Date: Sep. 3, 2026

(54) HIGH-CAPACITY DYNAMIC VERTIPORT

(71) Applicant: The Boeing Company, Arlington, VA (US)

(72) Inventors: Brendan Patrick WILLIAMS, Brisbane (AU); Reece Alexander CLOTHIER, Brisbane (AU)

(73) Assignee: The Boeing Company, Arlington, VA (US)

(21) Appl. No.: 19/067,325

(22) Filed: Feb. 28, 2025

(51) Int. Cl. B64F 1/22; B64C 29/00

(52) U.S. Cl. CPC B64F 1/22; E04H 6/44

(57) ABSTRACT

A vertiport system is disclosed that includes a plurality of touchdown and lift-off (TLOF) platforms and a driver configured to move the plurality of TLOF platforms with respect to a plurality of final approach and take-off (FATO) areas.

### TECHNICAL FIELD

The present teachings relate generally to a vertiport and, more particularly, to a high-capacity dynamic vertiport.

### BACKGROUND

A vertiport is an area of land, water, or structure that is used for the landing, take-off, and movement of vertical takeoff and landing (VTOL)-capable aircraft. A VTOL-capable aircraft is one that can take off and land vertically without relying on a runway. This classification can include a variety of types of aircraft including helicopters, thrust-vectoring fixed-wing aircraft, and other hybrid aircraft with powered rotors such as cyclogyros/cyclocopters and gyrodynes.

A large network of vertiports capable of supporting a very high throughput of VTOL aircraft movements may help create a commercially viable advanced air mobility (AAM) sector. The commercial use cases for AAM require many of these vertiports to be located in urban or densely congested areas (e.g., on top of buildings, carparks, etc.). Adequate sites are likely to be limited and expensive. Consequently, vertiports in urban areas will need to make very efficient use of the smallest possible geographical footprint. In tension with this is the need for throughput. The commercial business case of both the AAM operator and vertiport operator/owner only closes if there is a very high throughput of operations. However, under conventional vertiport/heliport designs, the capacity is limited.

Constraints on the size of vertiports may also limit the amount of ground support and landside infrastructure available at a vertiport (e.g., the number of charging/re-fueling bays, passenger access gates, maintenance areas, etc.). Conventional vertiport/heliport designs limit accessibility to services and equipment, warranting the use of mobile equipment, and/or the use of inefficient taxi/walk ways. Aircraft may need to be wheeled or taxi between stations, adding to journey time and potentially restricting use and/or reducing capacity. Finally, airspace design requirements will define the final approach and take-off area (FATO) area(s) for a vertiport. These will be limited in number, creating another potential bottleneck on vertiport throughput and/or limit on capacity. Therefore, what is needed is an improved vertiport system and a method for using it.

### SUMMARY

According to examples of the present disclosure, a vertiport system is disclosed. The vertiport system comprises a plurality of touchdown and lift-off (TLOF) platforms; and a driver configured to move the plurality of TLOF platforms with respect to a plurality of final approach and take-off (FATO) areas. Various additional features can be included in the vertiport system including one or more of the following features. The vertiport system can further comprise a plurality of stations, wherein the TLOF platforms move in a horizontal plane, a vertical plane, or a vertical and horizontal plane around or with respect to the plurality of stations. The plurality of stations can be offset from one another within a 3-dimensional volume. The TLOF platforms can be positioned radially-outward with respect to a central axis, and wherein each TLOF platform is configured to be aligned with a different one of the stations. The TLOF platforms can be positioned rectilinearly-outward with respect to a central point, and wherein each TLOF platform is configured to be aligned with a different one of the stations. One of plurality of the stations comprise a touchdown and lift-off (TLOF) station, an unloading station, a ground service station, and a loading station. One of the plurality of the stations comprise a touchdown and lift-off (TLOF) station, wherein the driver is configured to move a first of the TLOF platforms into alignment with the TLOF station and simultaneously into the FATO area, and wherein the first TLOF platform is configured to have a vertical takeoff and landing (VTOL) aircraft land thereon or depart from when the first TLOF platform is in the FATO area. One of the plurality of the stations comprise an unloading station, wherein the driver is configured to move a first of the TLOF platforms into alignment with the unloading station, which allows passengers, luggage, or cargo to be unloaded from a vertical takeoff and landing (VTOL) aircraft, onto the first TLOF platform, and then into the unloading station. One of the plurality of the stations comprise a ground service station, wherein the driver is configured to move a first of the TLOF platforms into alignment with the ground service station, which allows ground service to be performed on a vertical takeoff and landing (VTOL) aircraft that is positioned on the first TLOF platform. One of the plurality of the stations comprise a loading station, wherein the driver is configured to move a first of the TLOF platforms into alignment with the loading station, which allows passengers, luggage, or cargo to be loaded from the loading station onto the first TLOF platform, and then onto a vertical takeoff and landing (VTOL) aircraft. A dynamic pulse rate of the vertiport system is automatically coupled to advanced air mobility network demand and capacity management requirements determined by an air traffic management system. The one or more stations can be on the floors of a building and can be on either side of the TLOF platforms. The 3-dimensional structure can be entirely above ground, below ground with the FATOs being at ground level, or both above and below ground. The stations can be fixed around the outside of the rotation, not just stationary in the center. The stations can located round the circumference of the 3-dimensional structure.

According to examples of the present disclosure, a vertiport system is disclosed. The vertiport system comprises a 3-dimensional structure; a final approach and take-off (FATO) area arranged near a top of the 3-dimensional structure; a plurality of stations arranged within the 3-dimensional structure; a plurality of touchdown and lift-off (TLOF) platforms arranged within the 3-dimensional structure; and a driver configured to move the plurality of TLOF platforms in a vertical manner with respect to a central axis within the 3-dimensional structure. Various additional features can be included in the vertiport system including one or more of the following features. The driver can be coupled with one or more vertical elevators, one or more sliding platforms, or both, that are coupled with the each of the plurality of TLOF platforms. The driver can be an articulated arm that can attach and detach with each of the plurality of TLOF platforms. The plurality of stations can be offset from one another within a 3-dimensional volume. The TLOF platforms can be positioned radially-outward with respect to a central horizontal axis, and wherein each TLOF platform is configured to be aligned with a different one of the stations.

According to examples of the present disclosure, a method for operating a vertiport system is disclosed. The method can comprise moving a touchdown and lift-off (TLOF) platform into alignment in a vertical direction, a horizontal direction, or a combination of the vertical direction and the horizontal direction with a first station of a terminal, wherein the TLOF platform is moved with a driver, wherein the TLOF platform is within a final approach and take-off (FATO) area when the TLOF platform is aligned with the first station; and receiving a first vertical takeoff and landing (VTOL) aircraft onto the TLOF platform when the TLOF platform is aligned with the first station and in the FATO area. Various additional features can be included in the method including one or more of the following features. The method can further comprise moving the TLOF platform in a vertical direction, a horizontal direction, or a combination of the vertical direction and the horizontal direction from alignment with the first station of the terminal into alignment with a second station of the terminal; and unloading from the first VTOL aircraft when the TLOF platform is aligned with the second station. The method can further comprise moving the TLOF platform in a vertical direction, a horizontal direction, or a combination of the vertical direction and the horizontal direction from alignment with the second station of the terminal into alignment with a third station of the terminal; and performing a ground service on the first VTOL aircraft when the TLOF platform is aligned with the third station. The method can further comprise moving the TLOF platform in a vertical direction, a horizontal direction, or a combination of the vertical direction and the horizontal direction from alignment with the third station of the terminal into alignment with a fourth station of the terminal; loading into the first VTOL aircraft when the TLOF platform is aligned with the fourth station; moving the TLOF platform from alignment with the fourth station of the terminal into alignment with the first station of the terminal; and causing the first VTOL aircraft to take-off from the TLOF platform when the TLOF platform is aligned with the first station and in the FATO area.

### BRIEF DESCRIPTION OF THE DRAWINGS

The above and/or other aspects and advantages will become more apparent and more readily appreciated from the following detailed description of examples, taken in conjunction with the accompanying drawings, in which:

FIG. 1 illustrates a plan view of a vertiport system including a plurality of (e.g., four) touchdown and lift-off (TLOF) platforms, according to an embodiment.

FIG. 2 illustrates a flowchart of a method for operating the vertiport system, according to an embodiment.

FIG. 3 illustrates the vertiport system with the TLOF platforms rotated (e.g., about 45 degrees), according to an embodiment.

FIG. 4 illustrates the vertiport system with the TLOF platforms rotated (e.g., about 90 degrees), according to an embodiment.

FIG. 5 illustrates another example of a vertiport system in a side view according to examples of the present disclosure.

FIG. 6, FIG. 7, and FIG. 8 illustrate subsequent operation of one example operation of the vertiport system of FIG. 5.

FIG. 9A and FIG. 9B illustrate a “race track” configuration showing multiple FATOs according to examples of the present disclosure.

FIG. 10A and FIG. 10B illustrate a “silo” type or cylindrical structure arrangement showing multiple FATOs according to examples of the present disclosure.

FIG. 11A and FIG. 11B illustrate a third subsequent position and a fourth subsequent position of the arrangement shown in FIG. 10A and FIG. 10B according to examples of the present disclosure.

FIG. 12A and FIG. 12B illustrate a fifth subsequent position and a sixth subsequent position of the arrangement shown in FIG. 10A and FIG. 10B according to examples of the present disclosure.

FIG. 13 shows a flowchart for a method for operating a vertiport system according to examples of the present disclosure.

### DETAILED DESCRIPTION

Exemplary aspects will now be described more fully with reference to the accompanying drawings. Examples of the disclosure, however, can be embodied in many different forms and should not be construed as being limited to the examples set forth herein. Rather, these examples are provided so that this disclosure will be thorough and complete, and will fully convey the scope to those skilled in the art. In the drawings, some details may be simplified and/or may be drawn to facilitate understanding rather than to maintain strict structural accuracy, detail, and/or scale.

It will be understood that when an element is referred to as being “on,” “associated with,” “connected to,” “electrically connected to,” or “coupled to” to another component, it may be directly on, associated with, connected to, electrically connected to, or coupled to the other component or intervening components may be present. In contrast, when a component is referred to as being “directly on,” “directly associated with,” “directly connected to,” “directly electrically connected to,” or “directly coupled to” another component, there are no intervening components present. As used herein, the term “and/or” includes any and all combinations of one or more of the associated listed items.

It will be understood that although the terms first, second, etc., may be used herein to describe various elements, components, and/or directions, these elements, components, and/or directions should not be limited by these terms. These terms are only used to distinguish one element, component, and/or direction from another element, component, and/or direction. For example, a first element, component, or direction could be termed a second element, component, or direction without departing from the teachings of examples.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation(s) depicted in the figures.

The present disclosure includes a vertiport system (e.g., a vertihub, a vertiport, a vertistop, or a combination thereof) that enables the more efficient use of available physical space, airspace, and technical infrastructure. The design increases vertiport capacity (e.g., potential throughput of aircraft) for a smaller physical footprint and cost-effective use of limited ground equipment and services. More particularly, this may be achieved through “moveable” structural elements, the movement of which can be optimized for patterns of use or to enable greater access to limited services and/or infrastructure. This solves a challenge to the design and siting of vertiports, which may help to advance the emerging advance air mobility sector.

The vertiport system described herein includes a moveable design that enables more efficient use of a limited footprint and available ground support equipment and infrastructure. As described below, the vertiport system may include a final approach and take-off area (FATO), which is a defined area over which the pilot completes the final phase of the approach to a hover or a landing, and from which the pilot initiates take-off.

Conventional heliport and vertiport designs have a fixed gate and terminal area, which is linked to one or more touchdown and lift off (TLOF) area(s). The TLOF area may coincide with a FATO, or a FATO may be located a short distance away from the gate/terminal via a taxiway. Thus, the capacity of the conventional vertiport is fundamentally limited by the available space, which is designed for a “single occupancy” model. Capacity is directly proportional to the amount of available space. Increasing capacity requires an increase in the amount of space (e.g., additional FATOs, additional taxiway, apron, stand area, etc.).

Conventional designs also force a “sequential flow” of operations that is highly susceptible to disruption. For example, any delay to passenger embarkation or disembarkation, a late arrival, slow taxi, or broken-down aircraft, impacts the throughput of the entire vertiport. The tight energy reserves of AAM necessitates a highly predictable flight schedule, and any such delays at the vertiport (or reduction in planned capacity) has the potential cause significant and costly disruption across the entire AAM transportation network.

It is expected that vast numbers of vertiports will need to be located in densely populated and therefore costly and space-constrained areas. Existing designs are unlikely to be able to meet the capacity and dependability requirements needed for commercially sustainable AAM transport network.

The vertiport system may include a touchdown and lift-off area (TLOA), which is a load-bearing area surface on which the VTOL aircraft lands and/or takes off. The TLOA may be centered in the FATO. The vertiport system may include multiple moveable TLOFs. In this case, a TLOF becomes active when it coincides with one (or more) defined FATO.

The design includes a moveable infrastructure that makes optimum use of the available space. More particularly, the design makes optimum use of limited ground infrastructure (e.g., terminal, maintenance, charging, and/or fueling services) and airspace (e.g., limited FATO points).

The dynamic nature of the physical infrastructure allows for new opportunities to integrate vertiport operations with the broader airspace management system. For example, the vertiport can be pulsed and/or continuous—with the rate synchronized to needs of the broader network. In another example, the dynamic “pulse rate” of the vertiport can be automatically coupled to network demand and capacity management requirements determined by the air traffic management system.

The design has distinct advantages and could be used for either helicopter, eVTOL, and/or AAM aircraft. The advantages may include efficient use of space. More particularly, the design reduces the amount of space required for surface movement areas. The advantages also include higher capacity because the design supports greater capacity from a single FATO for the same corresponding ground footprint. The design may also enable more efficient surface operations by eliminating the need for aircraft to taxi and/or tow between gates, the TLOF, and the FATO. The design is also safer than conventional designs because it constrains passenger movement to non-operational phases and ensures physical separation between charging and other potentially hazardous surface activities. The advantages also include enhanced security because the design constrains passenger movement to certain areas. The advantages also include more efficient use of ground equipment because the design reduces the amount of ground infrastructure and services equipment required to service the same number of aircraft. The advantages also include ATM integration and network management because the design provides the ability to automatically synchronize vertiport movements and/or throughput with known schedule and/or slots, and network demand and capacity balancing actions. In turn, this drives greater predictability and reliability in on time departure and arrival performance across the route network. The advantages also include increased availability because the design reduces the impact of single aircraft breakdowns or delays on the operational performance of the vertiport.

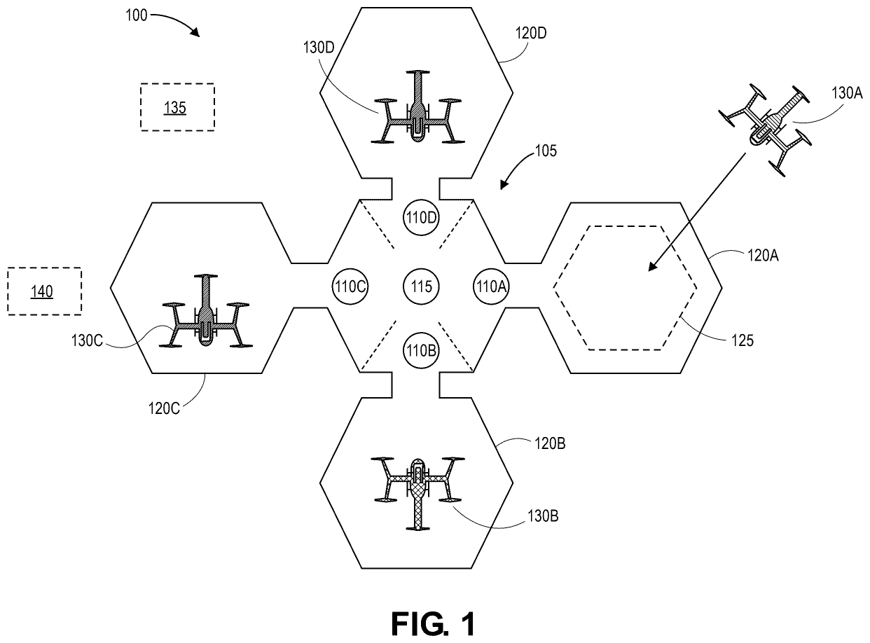

FIG. 1 illustrates a plan view of a vertiport system 100, according to an embodiment. The vertiport system 100 may be used for any scale and/or complexity of space-constrained vertiport including vertistops, vertihub, and vertiports and in either 2-D or 3-D spaces.

The vertiport system 100 may include a terminal 105. The terminal 105 may be stationary. The terminal may be divided into a plurality of (e.g., four) stations 110A-110D. The stations 110A-110D may be circumferentially offset from one another around a central vertical axis 115 through the terminal 105. In an example, the stations 110A-110D may include a touchdown and lift-off (TLOF) station 110A, an unloading station 110B, a ground service station 110C, a loading station 110D, a hangarage station (not shown), or a combination thereof. The stations 110A-110D may be in this order proceeding in a rotational (e.g., clockwise) direction around the axis 115. As described below, the TLOF station 110A may facilitate touchdown and/or lift-off of a vertical takeoff and landing (VTOL) aircraft. The unloading station 110B may be where first passengers, first luggage, and/or cargo are unloaded from the VTOL aircraft. The ground service station 110C may be where ground service is performed on the VTOL aircraft. The loading station 110D may be where second (e.g., different) passengers, luggage, and/or cargo are loaded into the VTOL aircraft. In some embodiments, the terminal 105 may be omitted.

In a different embodiment the plurality of (e.g., four) stations 110A-110D may be located around the circumference or outside of the plurality of (e.g., four) the TLOFs 120A-120D. In another embodiment the stations may be a combination of internal (inside the TLOFs) and external (outside of the TLOFs).

The vertiport system 100 may also include a plurality of (e.g., four or more or less) TLOF platforms 120A-120D. The TLOF platforms 120A-120D may be positioned adjacent to the terminal 105. The TLOF platforms 120A-120D may be positioned radially-outward in 2D or 3D from the terminal 105 and/or the stations 110A-110D with respect to the central vertical axis 115. Each TLOF platform 120A-120D may be configured to be aligned with a different one of the stations 110A-110D. The TLOF platforms 120A-120D may include landing and/or departure aids (e.g., lighting, approach navigational aids, departure navigational aids, etc.) or other ancillary equipment (e.g., general lighting) to meet regulatory or other requirements. In another embodiment, these aids and/or other ancillary equipment may be positioned elsewhere in the vertiport system 100.

The vertiport system 100 may also include one or more final approach and take-off (FATO) areas (one is shown: 125). The FATO area 125 may be positioned adjacent to the terminal 105. The FATO area 125 may be stationary. A first of the TLOF platforms (e.g., TLOF platform 120A) may be configured to initially be aligned with the TLOF station 110A of the terminal 105. The first FLOF platform 120A may also or instead be positioned at least partially in the FATO area 125. The first TLOF platform 120A may be configured to have a vertical takeoff and landing (VTOL) aircraft 130A land thereon when the first TLOF platform 120A is in the FATO area 125.

The vertiport system 100 may also include a driver (e.g., a motor) 135 configured to cause the TLOF platforms 120A-120D to move with respect to the terminal 105 and/or the FATO area 125. The TLOF platforms 120A-120D may move in a horizontal plane, a vertical plane, or a combination of a horizontal and vertical plane, around the central vertical axis 115 (e.g., in the clockwise direction). The TLOF platforms 120A-120D may also or instead move in a vertical direction and/or plane, or a combination of a vertical and horizontal direction and/or plane. The TLOF platforms 120A-120D may move in a continuous or pulsed manner. In an example, the continuous manner may include the TLOF platforms 120A-120D moving in a substantially circular path at a rate of about 1 meter per minute. In an example, the pulsed manner may include the TLOF platforms 120A-120D remaining in alignment with one of the stations 110A-110D for a predetermined amount of time (e.g., 10 minutes), and then moving in a substantially circular path to the next station 110A-110D.

The first TLOF platform 120A may move from alignment with the TLOF station 110A of the terminal 105 into alignment with the unloading station 110B of the terminal 105 in response to a first rotational movement by the driver 135, which allows first passengers, first luggage, and/or first cargo to be unloaded from the VTOL aircraft 130A into the unloading station 110B of the terminal 105. The first TLOF platform 120A may also move from alignment with the unloading station 110B of the terminal 105 into alignment with the ground service station 110C of the terminal 105 in response to a second rotational movement by the driver 135, which allows ground service to be performed on the VTOL aircraft 130A. The first TLOF platform 120A may move from alignment with the ground service station 110C of the terminal 105 into alignment with the loading station 110D of the terminal 105 in response to a third rotational movement by the driver 135, which allows second passengers, second luggage, and/or second cargo to be loaded from the loading station 110D of the terminal 105 into the VTOL aircraft 130A. The first TLOF platform 120A may also move from alignment with the loading station 110D of the terminal 105 back into alignment with the TLOF station 110A of the terminal 105 in response to a fourth rotational movement by the driver 135, which brings the first TLOF platform 120A back into the FATO area 125. The VTOL aircraft 130A is configured to takeoff from the first TLOF platform 120A when the first TLOF platform 120A moves back into the FATO area 125.

The foregoing portions of the vertiport system 100 (e.g., the terminal 105, the TLOF platforms 120A-120D, the FATO area 125, the driver 135, or a combination thereof) may be referred to as the dynamic infrastructure. In one embodiment, the vertiport system 100 may also include a static area 140 positioned adjacent to the terminal 105 and/or the TLOF platform(s) 120A-120D. In the example shown, the static area 140 is adjacent to the TLOF platform 120C. The static area 140 may be used to hold one or more VTOL aircraft if they need more time than is provided by the dynamic infrastructure described above. For example, if the VTOL aircraft 130A needs repairs that cannot be completed before cycling around back into the FATO area 125, then the VTOL aircraft 130A can be removed from the TLOF platform 120A and placed into the static area 140, where the repairs can be completed. Once the repairs are completed, the VTOL aircraft 130A can then be placed back onto the TLOF platform 120A.

In one embodiment, the removal of one of the VTOL aircraft from the dynamic infrastructure may be achieved by towing the VTOL aircraft between locations (e.g., from the TLOF platform 120A to the static area 140). In another embodiment, the removal may be achieved by detaching the TLOF platform 120A with the VTOL aircraft 130A thereon and moving the platform 120A and aircraft 130A to the static area 140. A different TLOF (that was outside the dynamic infrastructure) may then be attached in place of the removed TLOF platform 120A. The newly attached TLOF platform may either have a new/different VTOL aircraft thereon or no aircraft thereon. An embodiment may have both the detaching and/or attaching TLOF platforms and a separate hardstand area with ability to move aircraft between them. Another embodiment may have the detaching and/or attaching TLOFs, or just the hardstand area: all in addition to the dynamic infrastructure as currently described (including the terminal 105). In another embodiment the static areas may be located throughout the 3-dimensional structure.

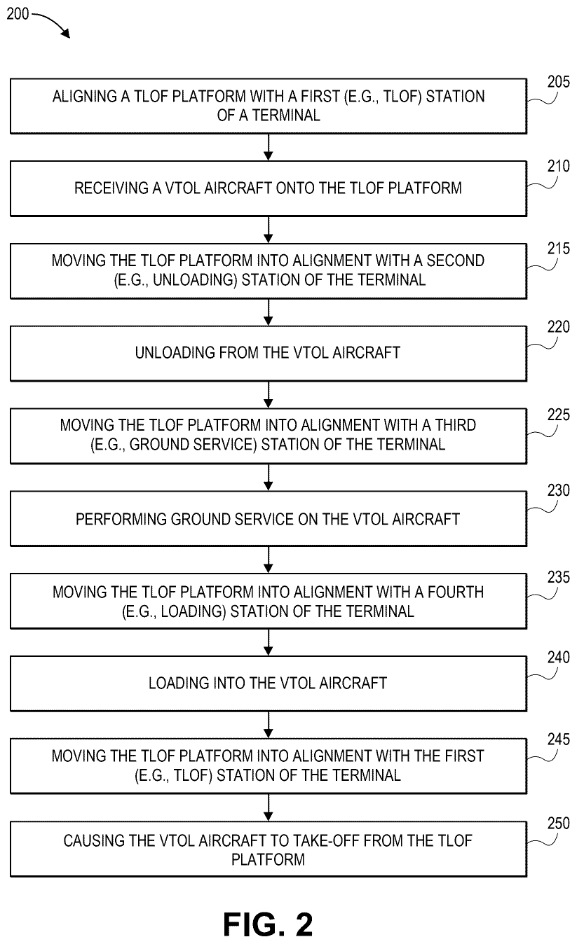

FIG. 2 illustrates a flowchart of a method 200 for operating the vertiport system 100, according to an embodiment. An illustrative order of the method 200 is provided below; however, one or more steps of the method 200 may be performed in a different order, simultaneously, repeated, or omitted.

The method 200 may include aligning the first TLOF platform 120A with the first (e.g., TLOF) station 110A of the terminal 105, as at 205,) in a vertical direction, a horizontal direction, or a combination of the vertical direction and the horizontal direction. This may also include aligning the second TLOF platform 120B with the second station 110B of the terminal 105, aligning the third TLOF platform 120C with the third station 110C of the terminal 105, and/or aligning the fourth TLOF platform 120D with the fourth station 110D of the terminal 105) in a vertical direction, a horizontal direction, or a combination of the vertical direction and the horizontal direction. In an embodiment, the first TLOF platform 120A may be in the FATO area 125 when the first TLOF platform 120A is aligned with the first station 110A) in a vertical direction, a horizontal direction, or a combination of the vertical direction and the horizontal direction.

The method 200 may also include receiving a first VTOL aircraft 130A onto the first TLOF platform 120A, as at 210. More particularly, the first VTOL aircraft 130A may land on the first TLOF platform 120A when the first TLOF platform 120A is in the FATO area 125. In one embodiment, a different VTOL aircraft (not shown) may be on the first TLOF platform 120A when the first TLOF platform 120A moves into the FATO area 125 and in alignment with the first (e.g., TLOF) station 110A, and the different VTOL aircraft may take-off from the first TLOF platform 120A just prior to the first VTOL aircraft 130A landing on the first TLOF platform 120A. The take-off and subsequent landing may both occur while the first TLOF platform 120A is/remains in the FATO area 125 and in alignment with the first (e.g., TLOF) station 110A. In another embodiment, the first VTOL aircraft 130A may land on an unoccupied TLOF station when it reaches the FATO area 125 on a subsequent cycle.

In an embodiment, the second TLOF platform 120B may have a second VTOL aircraft 130B positioned thereon, the third TLOF platform 120C may have a third VTOL aircraft 130C positioned thereon, and/or the fourth TLOF platform 120D may have a fourth VTOL aircraft 130D positioned thereon. However, the VTOL aircrafts 130A-130D may only land and/or take-off from their corresponding TLOF platform 120A-120D when the TLOF platform 120A-120D is in the FATO area 125. As a result, in this embodiment, only one VTOL aircraft 130A-130D may land and/or take-off at a time.

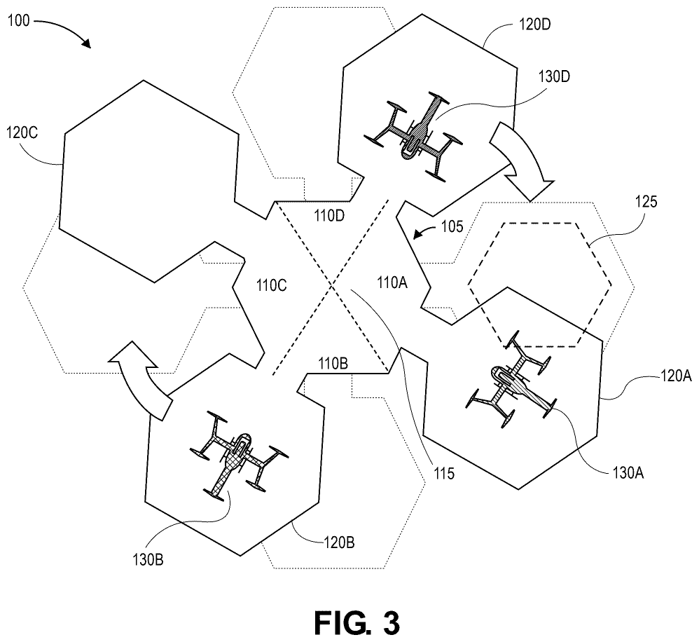

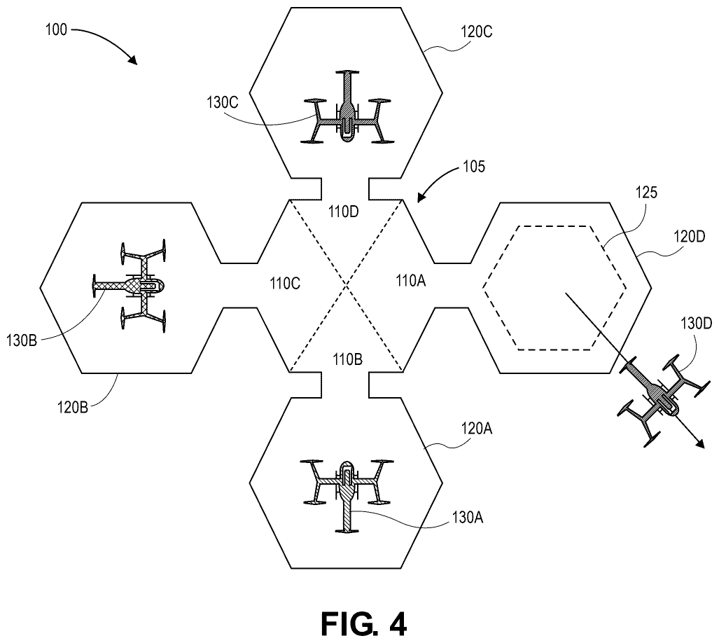

The method 200 may also include moving the first TLOF platform 120A from alignment with the first (e.g., TLOF) station 110A of the terminal 105 into alignment with the second (e.g., unloading) station 110B of the terminal 105, as at 215. FIG. 3 illustrates this movement, and FIG. 4 illustrates the completion of this movement, with the first TLOF platform 120A in alignment with the second (e.g., unloading) station 110B of the terminal 105.

This may also or instead (e.g., simultaneously) include moving the second TLOF platform 120B from alignment with the second (e.g., unloading) station 110B of the terminal 105 into alignment with the third (e.g., ground service) station 110C of the terminal 105, moving the third TLOF platform 120C from alignment with the third (e.g., ground service) station 110C of the terminal 105 into alignment with the fourth (e.g., loading) station 110D of the terminal 105, moving the fourth TLOF platform 120D from alignment with the fourth (e.g., loading) station 110D of the terminal 105 into alignment with the first (e.g., TLOF) station 110A of the terminal 105, or a combination thereof. More particularly, the driver 135 may generate a first rotational movement, which may cause the TLOF platforms 120A-120D to move/rotate (e.g., 90 degrees) around the axis 115. In one embodiment, the platforms 120A-120D may move along a (e.g., circular) track and/or rail that is positioned below the platforms 120A-120D. In another embodiment, the platforms 120A-120D may move on one or more wheels that are positioned therebelow.

The method 200 may also include unloading from the first VTOL aircraft 130A, as at 220. More particularly, first passengers, first luggage, and/or first cargo may be unloaded from the first VTOL aircraft 130A onto the first TLOF platform 120A, and then into the second (e.g., unloading) station 110B of the terminal 105 when the first TLOF platform is aligned with the second (e.g., unloading) station 110B of the terminal 105.

The method 200 may also include moving the first TLOF platform 120A from alignment with the second (e.g., unloading) station 110B of the terminal 105 into alignment with the third (e.g., ground service) station 110C of the terminal 105, as at 225, in a vertical direction, a horizontal direction, or a combination of the vertical direction and the horizontal direction. This may also or instead (e.g., simultaneously) include moving the second TLOF platform 120B from alignment with the third (e.g., ground service) station 110C of the terminal 105 into alignment with the fourth (e.g., loading) station 110D of the terminal 105, moving the third TLOF platform 120C from alignment with the fourth (e.g., loading) station 110D of the terminal 105 into alignment with the first (e.g., TLOF) station 110A of the terminal 105, moving the fourth TLOF platform 120D from alignment with the first (e.g., TLOF) station 110A of the terminal 105 into alignment with the second (e.g., unloading) station 110B of the terminal 105, or a combination thereof) in a vertical direction, a horizontal direction, or a combination of the vertical direction and the horizontal direction. More particularly, the driver 135 may generate a second rotational movement, which may cause the TLOF platforms 120A-120D to move/rotate (e.g., 90 degrees) around the axis 115) in a vertical direction, a horizontal direction, or a combination of the vertical direction and the horizontal direction.

The method 200 may also include performing ground service on the first VTOL aircraft 130A, as at 230. More particularly, the first VTOL aircraft 130A may be inspected, repaired, refueled, recharged, etc. when the first TLOF platform 120A is in alignment with the third (e.g., ground service) station 110C of the terminal 105.

The method 200 may also include moving the first TLOF platform 120A from alignment with the third (e.g., ground service) station 110C of the terminal 105 into alignment with the fourth (e.g., loading) station 110D of the terminal 105, as at 235, in a vertical direction, a horizontal direction, or a combination of the vertical direction and the horizontal direction. This may also or instead (e.g., simultaneously) include moving the second TLOF platform 120B from alignment with the fourth (e.g., loading) station 110D of the terminal 105 into alignment with the first (e.g., TLOF) station 110A of the terminal 105, moving the third TLOF platform 120C from alignment with the first (e.g., TLOF) station 110A of the terminal 105 into alignment with the second (e.g., unloading) station 110B of the terminal 105, moving the fourth TLOF platform 120D from alignment with the second (e.g., unloading) station 110B of the terminal 105 into alignment with the third (e.g., ground service) station 110C of the terminal 105, or a combination thereof ) in a vertical direction, a horizontal direction, or a combination of the vertical direction and the horizontal direction. More particularly, the driver 135 may generate a third rotational movement, which may cause the TLOF platforms 120A-120D to move/rotate (e.g., 90 degrees) around the axis 115) in a vertical direction, a horizontal direction, or a combination of the vertical direction and the horizontal direction.

The method 200 may also include loading into the first VTOL aircraft, as at 240. More particularly, second passengers, second luggage, and/or second cargo may be loaded into the first VTOL aircraft 130A when the first TLOF platform 120A is aligned with the fourth (e.g., loading) station 110D of the terminal 105.

The method 200 may also include moving the first TLOF platform 120A from alignment with the fourth (e.g., loading) station 110D of the terminal 105 into alignment with the first (e.g., TLOF) station 110A of the terminal 105, as at 245, in a vertical direction, a horizontal direction, or a combination of the vertical direction and the horizontal direction. This may also or instead (e.g., simultaneously) include moving the second TLOF platform 120B from alignment with the first (e.g., TLOF) station 110A of the terminal 105 into alignment with the second (e.g., unloading) station 110B of the terminal 105, moving the third TLOF platform 120C from alignment with the second (e.g., unloading) station 110B of the terminal 105 into alignment with the third (e.g., ground service) station 110C of the terminal 105, moving the fourth TLOF platform 120D from alignment with the third (e.g., ground service) station 110C of the terminal 105 into alignment with the fourth (e.g., loading) station 110D of the terminal 105, or a combination thereof ) in a vertical direction, a horizontal direction, or a combination of the vertical direction and the horizontal direction. More particularly, the driver 135 may generate a fourth rotational movement, which may cause the TLOF platforms 120A-120D to move/rotate (e.g., 90 degrees) around the axis 115 in a vertical direction, a horizontal direction, or a combination of the vertical direction and the horizontal direction.

The method 200 may also include causing or enabling the first VTOL aircraft 130A to take-off from the first TLOF platform 120A, as at 250. More particularly, the first VTOL aircraft 130A may take-off from the first TLOF platform 120A when the first TLOF platform 120A is in the FATO area 125.

According to examples of the present disclosure, another vertiport system (e.g., a vertihub, a vertiport, or a vertistop or a combination thereof) is disclosed that enables more efficient use of available physical space, airspace, or technical infrastructure, which is achieved through one or more moveable structural elements. The number of moveable structural elements, the movement of the one or more movable structural elements, or both can be optimized for various patterns of use or to enable greater access to limited services/infrastructure. These arrangements can help solve a significant challenge to the design and siting of vertiports which can be an enabler to the emerging advance air mobility sector. Theses designs/arrangements can increase vertiport capacity (potential throughput of aircraft) for a smaller physical footprint and cost-effective use of limited ground equipment and services.

According to examples, the movement can be in a horizontal plane, a vertical plane, or in a combination of the vertical plane and the horizontal plane. On one example, a series of TLOFs can be arranged on lifts or arranged in a Ferris wheel type/like arrangement where the lifts are supported by individual supports or spokes that are connected to a common central hub or drive and rotate in a clockwise, a counterclockwise, or back and forth depending on the use of the vertiport system in a vertical circular manner about the common central hub. In this example, a roof area of a structure housing the vertiport system can include the FATO(s) and the ancillary areas can be arranged on lower floors of the structure.

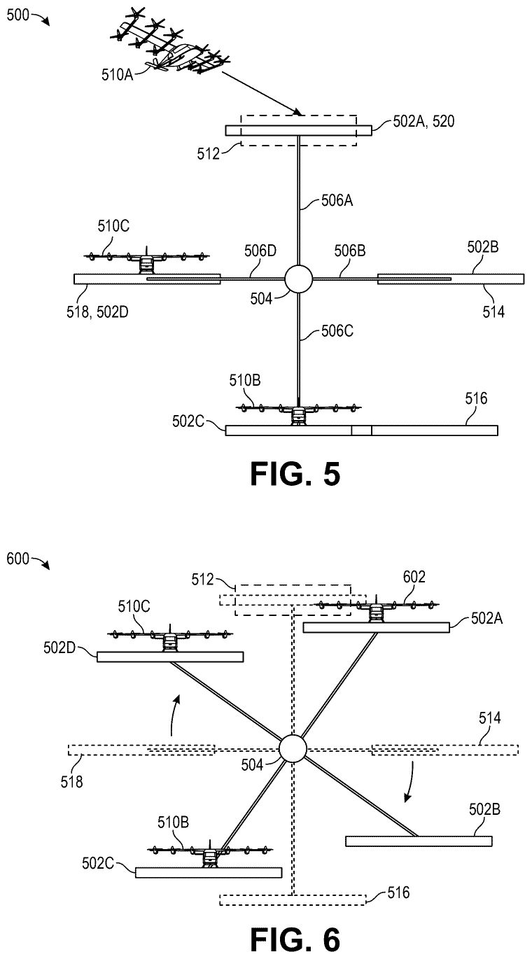

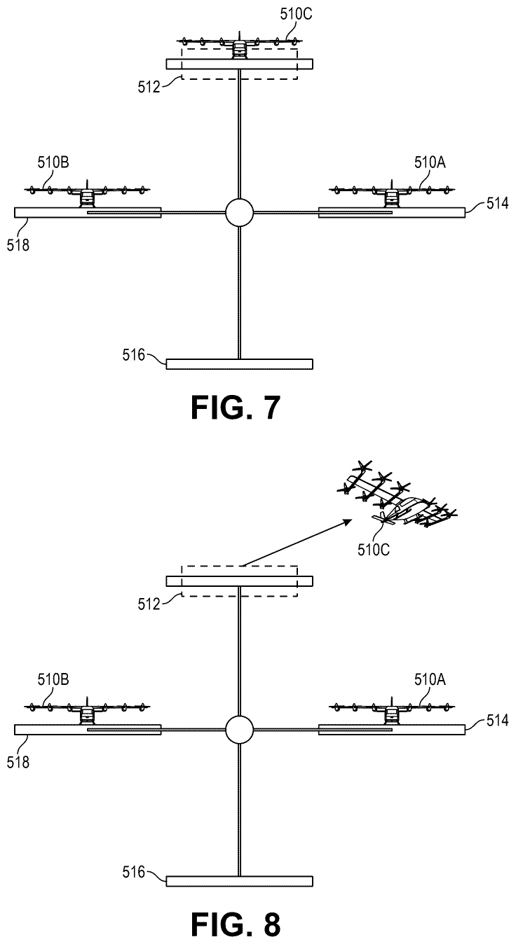

FIG. 5 illustrates another example of a vertiport system 500 in a side view according to examples of the present disclosure. As shown in FIG. 5 and FIG. 6, the vertiport system 500 comprises a plurality of TLOF platforms 502A, 502B, 502C, 502D arranged in a Ferris wheel type/like arrangement where each TLOF platform 502A, 502B, 502C, 502D is connected to a common central hub or driver 504 by respective supports or spokes 506A, 506B, 506C, 506D. As shown in FIG. 5, there are four TLOF platforms; however, this is just one example of the vertiport system 500. The vertiport system 500 can include less than or more than four TLOF platforms depending on a particular use scenario of the vertiport system 500. The plurality of TLOF platforms 502A, 502B, 502C, 502D can be configured to rotate in a clockwise, a counterclockwise, or back and forth in a continuous or pulsed manner in a vertical circular manner about the common central hub or driver 504 depending on the use of the vertiport system 500. Also as shown in FIG. 5, the TLOF platform 502A is arranged at a top position, such as a 12 o'clock position, the TLOF platform 502B is arranged at a middle position, such as a 3 o'clock position, the TLOF platform 502C is arranged at a bottom position, such as a 6 o'clock position, and the TLOF platform 502D is arranged the middle position, such as a 9 o'clock position.

In the arrangement as shown in FIG. 5, when the TLOF platform 502A is at the top position, the TLOF platform 502A can function as a FATO area 520 for a first VTOL aircraft 510A with a TLOF station or platform 512. When the TLOF platform 502B is at the middle position at the 3 o'clock position, The TLOF platform 502B can function with an unloading station for items, such as a previously landed VTOL. When the TLOF platform 502C is at the bottom position, the TLOF platform 502C can function with a ground service station. When the TLOF platform 502D is at the middle position at the 9 o'clock position, the TLOF platform 502D can function with a loading station.

Alternatively, the arrangement as shown in FIG. 5 can be operated by the common central hub or driver 504 moving the plurality of TLOF platforms 502A, 502B, 502C, 502D in a clockwise fashion such that each of the plurality of TLOF platforms 502A, 502B, 502C, 502D is serviced by each respective station (e.g., TLOF station, unloading station, ground service station, and loading station). When the TLOF platform 502A is at the top position, the TLOF platform 502A can function as the FATO for a first VTOL aircraft 510A with TLOF station. After the VTOL aircraft has landed, the common central hub or driver 504 rotates the TLOF platform 502A to the middle position at the 3 o'clock position for unloading at the unloading station 514. After unloading, the common central hub or driver 504 rotates the TLOF platform 502A to the bottom position where the ground service station is located. After services by the ground service station 516, the common central hub or driver 504 rotates the TLOF platform 502A to the middle position at the 9 o'clock position for loading of another VTOL aircraft at loading station 518. After loading, the common central hub or driver 504 rotates the TLOF platform 502A to the top position where the VTOL aircraft can take off and another VTOL aircraft can later land.

FIG. 6, FIG. 7, and FIG. 8 illustrate one example operation of the vertiport system 500 of FIG. 5. In FIG. 6, after the first VTOL aircraft 510A has landed on the TLOF platform 502A, the TLOF platform 502A is rotated to the unloading station 514. In FIG. 7, a second VTOL aircraft 510B is on a TLOF station or platform 512, is then rotated from the ground service station 516 to the loading station 518. In FIG. 8, a third VTOL aircraft 510C on the TLOF station or platform 512 is rotated from the loading station or platform 518 to the TLOF station or platform 512 (which is aligned with the FATO). The third VTOL aircraft 510C can take off when positioned at the TLOF station which is aligned with the FATO, as shown in FIG. 8.

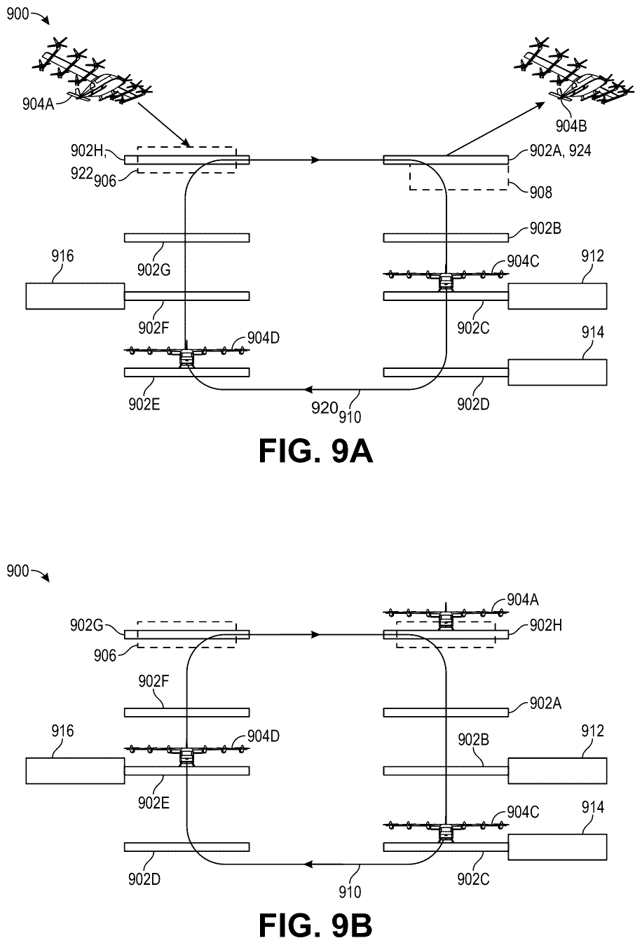

FIG. 9A and FIG. 9B illustrate a “race track” configuration 900 showing multiple FATOs (aligned with stations 906 and 908) according to examples of the present disclosure. FIG. 9A shows a first position of the “race track” configuration and FIG. 9B shows a second subsequent position after the platforms are moved in a clockwise manner by a driver 920. In this “race track” configuration, a plurality of platforms (e.g., platform 902A, 902B, 902C, 902D, 902E, 902F, 902G, 902H) rotates in a vertical circular manner about a common center in a clockwise manner (as shown), a counterclockwise manner, or back and forth between these two modes in either a continuous or pulsed manner using a track 910 depending on a particular usage case involved. As shown in FIG. 9A, a first TLOF platform, such as platform 902H, is at TLOF station 906 and is configured to receive a first VTOL aircraft 904A and a second VTOL aircraft 904B takes off from a second TLOF platform, such as platform 908. A third VTOL aircraft 904C is on platform 902C at unloading station 912. In FIG. 9B, the third VTOL aircraft 904C has moved to a ground service station 914 and a fourth VTOL aircraft 904D is moved to a loading station 916.

The examples of FIG. 9A and FIG. 9B allow for multiple unloading, ground service, and loading stations that can support efficient use of the multiple FATO configuration without a limit on the number of TLOFs, stations or FATOs. The movement mechanism can be rotational (like a Ferris wheel as described above) or through one or more vertical and horizontal translations (lift and shift via sliding platforms and elevators).

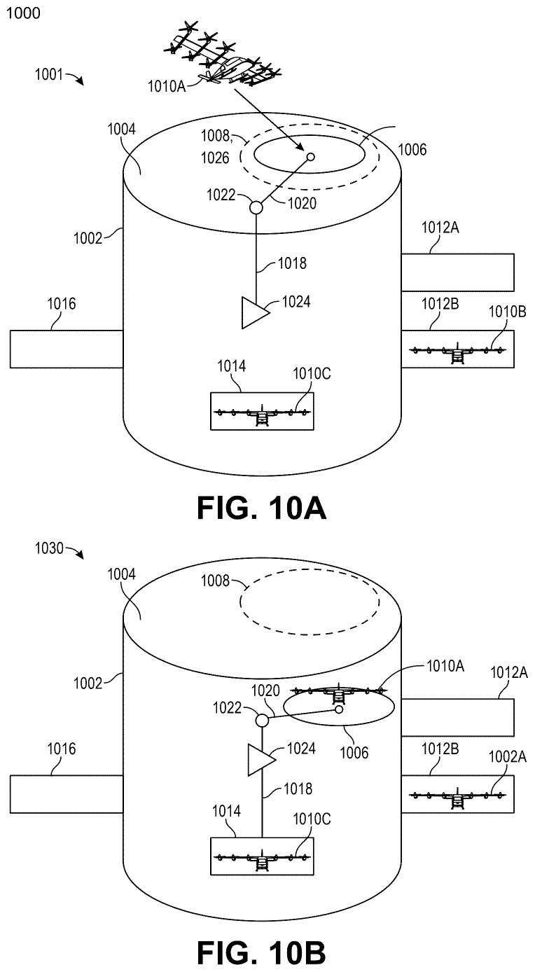

FIG. 10A and FIG. 10B illustrate a vertiport system 1000 arranged in a “silo” type or cylindrical structure arrangement showing multiple FATOs according to examples of the present disclosure. FIG. 10A shows a first position 1001 of the “silo”-type track” or cylindrical structure arrangement and FIG. 10B shows a second subsequent position 1030 after the platforms are moved. As shown in FIG. 10A and FIG. 10B, the silo 1002 comprises top region 1004 with a movable TLOF platform 1006 within a larger landing area 1008 (i.e., FATO) for landing and takeoff of one or more VTOL aircrafts, such a first VTOL aircraft 1010A shown approaching the landing area 1008, a first unloading station 1012A, which is shown empty of VTOL aircraft, a second unloading station 1012B that is shown servicing a second VTOL aircraft 1010B, a ground station 1014 that is shown servicing a third VTOL aircraft 1010C, and a first loading station 1016 that is shown empty of VTOL aircraft. The silo 1002 also includes one or more movement mechanisms, such as one or more articulated arms 1018, 1020 connected by joint 1022 and actuated by an actuator or driver 1024 that can move the one or more articulated arms 1018, 1020 individually or in combination. In FIG. 10A, the TLOF platform 1006 is at a top position of the silo 1002. In FIG. 10B, the TLOF platform 1006 has been lowered into the body of the silo 1002 by actuating the one or more articulated arms 1018, 1020 by the actuator or driver 1024. In this example configuration, the actuator or driver 1024 can actuate the one or more articulated arms 1018, 1020 can provide multi-dimensional (vertical and horizontal) movement to the various movable areas/stations. The movement of one or more articulated arms 1018, 1120 can be achieved using a combination of a vertical elevator and sliding platform (horizontal/radially). In some examples, various the stations may be dedicated with the TLOF platform (and VTOL aircraft) and moved between them by the articulated arm or the stations may be multi-functional (i.e., unloading, loading, ground service, or any combination thereof).

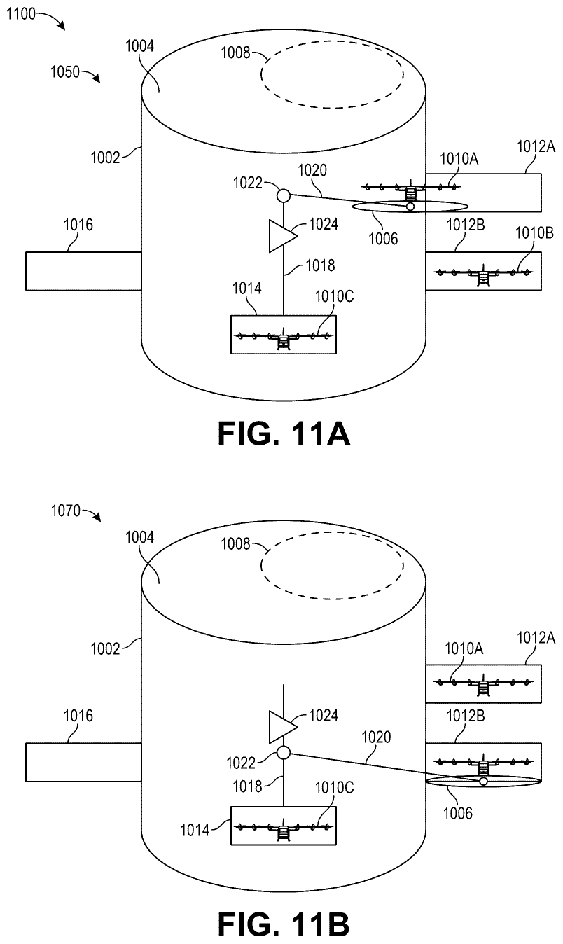

FIG. 11A and FIG. 11B illustrate a third subsequent position 1050 and a fourth subsequent position 1070 of the arrangement shown in FIG. 10A and FIG. 10B according to examples of the present disclosure. As shown in FIG. 11A, the TLOF platform 1006 with the first VTOL aircraft 1010A is lowered within the silo 1002 and into the first unloading station 1012A using the one or more articulated arms 1018, 1020. As shown in FIG. 11B, after the first VTOL aircraft 1010A is moved to the first unloading station 1012A, the TLOF platform 1006 is moved to the second unloading station 1012B to move the second VTOL aircraft 1010B using the one or more articulated arms 1018, 1020.

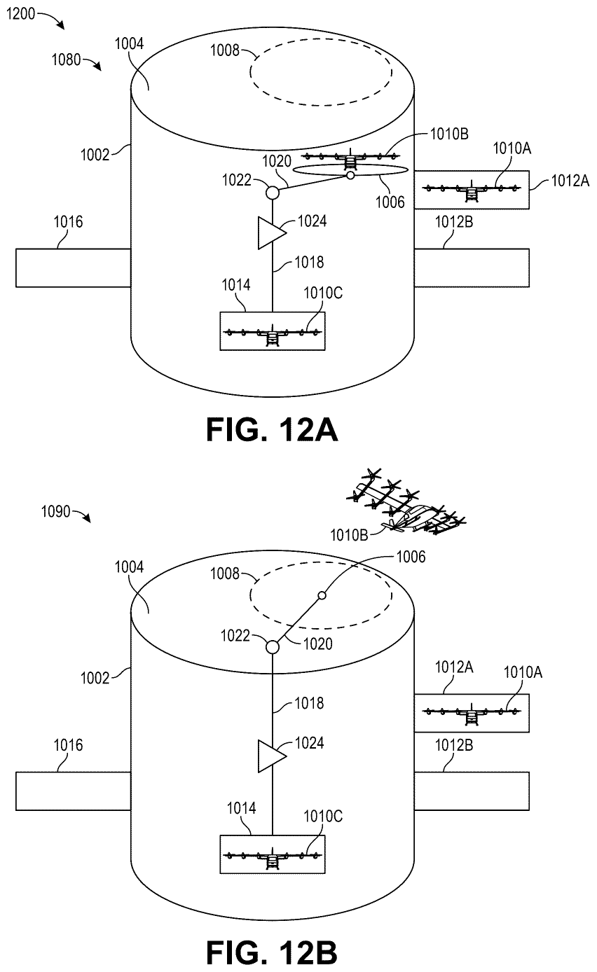

FIG. 12A and FIG. 12B illustrate a fifth subsequent position 1080 and a sixth subsequent position 1090 of the arrangement shown in FIG. 10A and FIG. 10B according to examples of the present disclosure. As shown in FIG. 12A, the TLOF platform 1006 with the second VTOL aircraft 1010B is raised within the silo 1002 from the first unloading station 1012A using the one or more articulated arms 1018, 1020. As shown in FIG. 12B, after the second VTOL aircraft 1010B is moved from the first unloading station 1012A, the TLOF platform 1006 is moved to the top 1004 of the silo 1002 using the one or more articulated arms 1018, 1020 so that the second VTOL aircraft 1010B can takeoff from the TLOF platform 1006.

The silo-type arrangements can provide for multi-dimensional movement with a horizontal vertiport operating area and storage/ground service below, such as at the ground station 1014. The multi-dimensional movement can be achieved using the one or more articulated arms 1018, 1020 in combination with one or more vertical elevators and one or more sliding platforms (horizontal/radially). Another embodiment has multiple TLOF platforms that can attach and detach to the one or more articulated arms, in combination with one or more vertical elevators and one or more sliding platforms (horizontal/radially), to facilitate movement between stations.

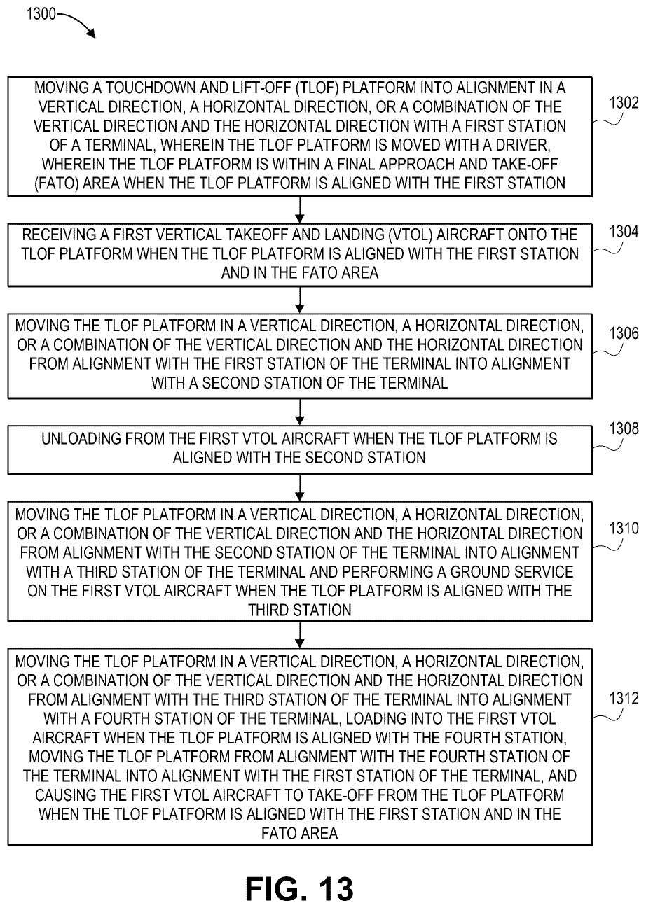

FIG. 13 shows a flowchart 1300 for a method for operating a vertiport system according to examples of the present disclosure. The method comprises moving a touchdown and lift-off (TLOF) platform into alignment in a vertical direction, a horizontal direction, or a combination of the vertical direction and the horizontal direction with a first station of a terminal, wherein the TLOF platform is moved with a driver, wherein the TLOF platform is within a final approach and take-off (FATO) area when the TLOF platform is aligned with the first station, as in 1302.

The method continues by receiving a first vertical takeoff and landing (VTOL) aircraft onto the TLOF platform when the TLOF platform is aligned with the first station and in the FATO area, as in 1304.

The method continues by moving the TLOF platform in a vertical direction, a horizontal direction, or a combination of the vertical direction and the horizontal direction from alignment with the first station of the terminal into alignment with a second station of the terminal, as in 1306. The method continues by unloading from the first VTOL aircraft when the TLOF platform is aligned with the second station, as in 1308.

The method continues by moving the TLOF platform in a vertical direction, a horizontal direction, or a combination of the vertical direction and the horizontal direction from alignment with the second station of the terminal into alignment with a third station of the terminal and performing a ground service on the first VTOL aircraft when the TLOF platform is aligned with the third station, as in 1310.

The method continues by moving the TLOF platform in a vertical direction, a horizontal direction, or a combination of the vertical direction and the horizontal direction from alignment with the third station of the terminal into alignment with a fourth station of the terminal, loading into the first VTOL aircraft when the TLOF platform is aligned with the fourth station, moving the TLOF platform from alignment with the fourth station of the terminal into alignment with the first station of the terminal, and causing the first VTOL aircraft to take-off from the TLOF platform when the TLOF platform is aligned with the first station and in the FATO area, as in 1312.

### CLAUSES

Clause 1. A vertiport system, comprising: a plurality of touchdown and lift-off (TLOF) platforms; and a driver configured to move the plurality of TLOF platforms with respect to a plurality of final approach and take-off (FATO) areas.
Clause 2. The vertiport system of clause 1, further comprises a plurality of stations, wherein the TLOF platforms move in a horizontal plane, a vertical plane, or a vertical and horizontal plane around or with respect to the plurality of stations.
Clause 3. The vertiport system of clause 1 or clause 2, wherein the plurality of stations are offset from one another within a 3-dimensional volume.
Clause 4. The vertiport system of any of clauses 1-3, wherein the TLOF platforms are positioned radially-outward with respect to a central axis, and wherein each TLOF platform is configured to be aligned with a different one of the stations.
Clause 5. The vertiport system of any of clauses 1-4, wherein the TLOF platforms are positioned rectilinearly-outward with respect to a central point, and wherein each TLOF platform is configured to be aligned with a different one of the stations.
Clause 6. The vertiport system of any of clauses 1-5, wherein one of the plurality of the stations comprise a touchdown and lift-off (TLOF) station, an unloading station, a ground service station, and a loading station.
Clause 7. The vertiport system of any of clauses 1-6, wherein one of the plurality of the stations comprise a touchdown and lift-off (TLOF) station, wherein the driver is configured to move a first of the TLOF platforms into alignment with the TLOF station and simultaneously into the FATO area, and wherein the first TLOF platform is configured to have a vertical takeoff and landing (VTOL) aircraft land thereon or depart from when the first TLOF platform is in the FATO area.
Clause 8. The vertiport system of any of clauses 1-7, wherein one of the plurality of the stations comprise an unloading station, wherein the driver is configured to move a first of the TLOF platforms into alignment with the unloading station, which allows passengers, luggage, or cargo to be unloaded from a vertical takeoff and landing (VTOL) aircraft, onto the first TLOF platform, and then into the unloading station.
Clause 9. The vertiport system of any of clauses 1-8, wherein one of the plurality of the stations comprise a ground service station, wherein the driver is configured to move a first of the TLOF platforms into alignment with the ground service station, which allows ground service to be performed on a vertical takeoff and landing (VTOL) aircraft that is positioned on the first TLOF platform.
Clause 10. The vertiport system of any of clauses 1-9, wherein one of the plurality of the stations comprise a loading station, wherein the driver is configured to move a first of the TLOF platforms into alignment with the loading station, which allows passengers, luggage, or cargo to be loaded from the loading station onto the first TLOF platform, and then onto a vertical takeoff and landing (VTOL) aircraft.
Clause 11. The vertiport system of any of clauses 1-10, wherein a dynamic pulse rate of the vertiport system is automatically coupled to advanced air mobility network demand and capacity management requirements determined by an air traffic management system.
Clause 12. A vertiport system, comprising: a 3-dimensional structure; a final approach and take-off (FATO) area arranged near a top of the 3-dimensional structure; a plurality of stations arranged within the 3-dimensional structure; a plurality of touchdown and lift-off (TLOF) platforms arranged within the 3-dimensional structure; and a driver configured to move the plurality of TLOF platforms in a vertical manner with respect to a central axis within the 3-dimensional structure.
Clause 13. The vertiport system of clause 12, wherein the driver is coupled with one or more vertical elevators, one or more sliding platforms, or both, that are coupled with the each of the plurality of TLOF platforms.
Clause 14. The vertiport system of clause 11 or clause 12, wherein the driver is an articulated arm that can attach and detach with each of the plurality of TLOF platforms.
Clause 15. The vertiport system of any of clauses 12-14, wherein the plurality of stations are offset from one another within a 3-dimensional volume.
Clause 16. The vertiport system of any of clauses 12-15, wherein the TLOF platforms are positioned radially-outward with respect to a central horizontal axis, and wherein each TLOF platform is configured to be aligned with a different one of the stations.
Clause 17. A method for operating a vertiport system, the method comprising: moving a touchdown and lift-off (TLOF) platform into alignment in a vertical direction, a horizontal direction, or a combination of the vertical direction and the horizontal direction with a first station of a terminal, wherein the TLOF platform is moved with a driver, wherein the TLOF platform is within a final approach and take-off (FATO) area when the TLOF platform is aligned with the first station; and receiving a first vertical takeoff and landing (VTOL) aircraft onto the TLOF platform when the TLOF platform is aligned with the first station and in the FATO area.
Clause 18. The method of clause 17, further comprising: moving the TLOF platform in a vertical direction, a horizontal direction, or a combination of the vertical direction and the horizontal direction from alignment with the first station of the terminal into alignment with a second station of the terminal; and unloading from the first VTOL aircraft when the TLOF platform is aligned with the second station.
Clause 19. The method of clause 17 or clause 18, further comprising: moving the TLOF platform in a vertical direction, a horizontal direction, or a combination of the vertical direction and the horizontal direction from alignment with the second station of the terminal into alignment with a third station of the terminal; and performing a ground service on the first VTOL aircraft when the TLOF platform is aligned with the third station.
Clause 20. The method of any of clauses 17-19, further comprising: moving the TLOF platform in a vertical direction, a horizontal direction, or a combination of the vertical direction and the horizontal direction from alignment with the third station of the terminal into alignment with a fourth station of the terminal; loading into the first VTOL aircraft when the TLOF platform is aligned with the fourth station; moving the TLOF platform from alignment with the fourth station of the terminal into alignment with the first station of the terminal; and causing the first VTOL aircraft to take-off from the TLOF platform when the TLOF platform is aligned with the first station and in the FATO area.

In one embodiment, the movement of the vertiport system 100 may be coupled to the broader airspace management system. For example, the movement of the vertiport system 100 may be synchronized with the movement of airspace slots (e.g., demand capacity balancing) via connection to a system such as System Wide Information Management (SWIM). The synchronization of movement with airspace and DCB requirements to support the efficient and sustainable airspace network has not been done before.

While the foregoing disclosure has been described in some detail by way of illustration and example for purposes of clarity and understanding, it will be clear to one of ordinary skill in the art from a reading of this disclosure that various changes in form and detail can be made without departing from the true scope of the disclosure and may be practiced within the scope of the appended claims. For example, all the methods, systems, and/or component parts or other aspects thereof can be used in various combinations. All patents, patent applications, websites, other publications or documents, and the like cited herein are incorporated by reference in their entirety for all purposes to the same extent as if each individual item were specifically and individually indicated to be so incorporated by reference.

What is claimed is:

1. A vertiport system, comprising:
a plurality of touchdown and lift-off (TLOF) platforms; and
a driver configured to move the plurality of TLOF platforms with respect to a plurality of final approach and take-off (FATO) areas.

2. The vertiport system of claim 1, further comprises a plurality of stations, wherein the TLOF platforms move in a horizontal plane, a vertical plane, or a vertical and horizontal plane around or with respect to the plurality of stations.

3. The vertiport system of claim 2, wherein the plurality of stations are offset from one another within a 3-dimensional volume.

4. The vertiport system of claim 3, wherein the TLOF platforms are positioned radially-outward with respect to a central axis, and wherein each TLOF platform is configured to be aligned with a different one of the stations.

5. The vertiport system of claim 3, wherein the TLOF platforms are positioned rectilinearly-outward with respect to a central point, and wherein each TLOF platform is configured to be aligned with a different one of the stations.

6. The vertiport system of claim 3, wherein one of the plurality of the stations comprise a touchdown and lift-off (TLOF) station, an unloading station, a ground service station, a loading station, and a static area for holding one or more VTOL aircraft.

7. The vertiport system of claim 3, wherein one of the plurality of the stations comprise a touchdown and lift-off (TLOF) station, wherein the driver is configured to move a first of the TLOF platforms into alignment with the TLOF station and simultaneously into the FATO area, and wherein the first TLOF platform is configured to have a vertical takeoff and landing (VTOL) aircraft land thereon or depart from when the first TLOF platform is in the FATO area.

8. The vertiport system of claim 3, wherein one of the plurality of the stations comprise an unloading station, wherein the driver is configured to move a first of the TLOF platforms into alignment with the unloading station, which allows passengers, luggage, or cargo to be unloaded from a vertical takeoff and landing (VTOL) aircraft, onto the first TLOF platform, and then into the unloading station.

9. The vertiport system of claim 3, wherein one of the plurality of the stations comprise a ground service station, wherein the driver is configured to move a first of the TLOF platforms into alignment with the ground service station, which allows ground service to be performed on a vertical takeoff and landing (VTOL) aircraft that is positioned on the first TLOF platform.

10. The vertiport system of claim 3, wherein one of the plurality of the stations comprise a loading station, wherein the driver is configured to move a first of the TLOF platforms into alignment with the loading station, which allows passengers, luggage, or cargo to be loaded from the loading station onto the first TLOF platform, and then onto a vertical takeoff and landing (VTOL) aircraft.

11. The vertiport system of claim 1, wherein a dynamic pulse rate of the vertiport system is automatically coupled to advanced air mobility network demand and capacity management requirements determined by an air traffic management system.

12. A vertiport system, comprising:
a 3-dimensional structure;
a final approach and take-off (FATO) area arranged near a top of the 3-dimensional structure;
a plurality of stations arranged within the 3-dimensional structure;
a plurality of touchdown and lift-off (TLOF) platforms arranged within the 3-dimensional structure; and
a driver configured to move the plurality of TLOF platforms in a vertical manner with respect to a central axis within the 3-dimensional structure.

13. The vertiport system of claim 12, wherein the driver is coupled with one or more vertical elevators, one or more sliding platforms, or both, that are coupled with the each of the plurality of TLOF platforms.

14. The vertiport system of claim 12, wherein the driver is an articulated arm that can attach and detach with each of the plurality of TLOF platforms.

15. The vertiport system of claim 12, wherein the plurality of stations are offset from one another within a 3-dimensional volume.

16. The vertiport system of claim 12, wherein the TLOF platforms are positioned radially-outward with respect to a central horizontal axis, and wherein each TLOF platform is configured to be aligned with a different one of the stations.

17. A method for operating a vertiport system, the method comprising:
moving a touchdown and lift-off (TLOF) platform into alignment in a vertical direction, a horizontal direction, or a combination of the vertical direction and the horizontal direction with a first station of a terminal, wherein the TLOF platform is moved with a driver, wherein the TLOF platform is within a final approach and take-off (FATO) area when the TLOF platform is aligned with the first station; and
receiving a first vertical takeoff and landing (VTOL) aircraft onto the TLOF platform when the TLOF platform is aligned with the first station and in the FATO area.

18. The method of claim 17, further comprising:
moving the TLOF platform in a vertical direction, a horizontal direction, or a combination of the vertical direction and the horizontal direction from alignment with the first station of the terminal into alignment with a second station of the terminal; and
unloading from the first VTOL aircraft when the TLOF platform is aligned with the second station.

19. The method of claim 18, further comprising:
moving the TLOF platform in a vertical direction, a horizontal direction, or a combination of the vertical direction and the horizontal direction from alignment with the second station of the terminal into alignment with a third station of the terminal; and
performing a ground service on the first VTOL aircraft when the TLOF platform is aligned with the third station.

20. The method of claim 19, further comprising:
moving the TLOF platform in a vertical direction, a horizontal direction, or a combination of the vertical direction and the horizontal direction from alignment with the third station of the terminal into alignment with a fourth station of the terminal;
loading into the first VTOL aircraft when the TLOF platform is aligned with the fourth station;
moving the TLOF platform from alignment with the fourth station of the terminal into alignment with the first station of the terminal; and
causing the first VTOL aircraft to take-off from the TLOF platform when the TLOF platform is aligned with the first station and in the FATO area.
